(19) United States
(12) Patent Application Publication
(10) Pub. No.: US 2024/0070724 A1
(43) Pub. Date: Feb. 29, 2024

(54) ITEM PROFILE ATTRIBUTE SYSTEM

(71) Applicant: International Business Machines Corporation, Armonk, NY (US)

(72) Inventors: Raghuveer Prasad Nagar, Kota (IN); Gaurav Mahesh Pandit, Puntamaba (IN); Harshit Sharma, Hathras (IN); Smitha Majur, Bengaluru (IN)

(21) Appl. No.: 17/821,639

(22) Filed: Aug. 23, 2022

(51) Int. Cl. G06Q 30/02; G06Q 30/06

(52) U.S. Cl. CPC G06Q 30/0271; G06Q 30/0253; G06Q 30/0631

(57) ABSTRACT

A computer implemented method, apparatus, system, and computer program product for recommending item attributes. A computer system determines the item attributes in an item profile for an item offered by a seller on an item transaction platform. The computer system identifies interactions between the seller and a potential buyer regarding the item. The computer system determines a set of missing item attributes from the item profile based on the interactions between the seller and the potential buyer. The computer system recommends a set of actions for the set of missing item attributes identified to a seller of the item in a recommendation. The computer system performs a set of actions in the recommendation using the set of missing item attributes in response to a user input from the seller responding to the recommendation.

### BACKGROUND

### 1. Field

The disclosure relates generally to an improved data processing system and more specifically to a method, apparatus, system, and computer program product for adding attributes to an item being offered.

### 2. Description of the Related Art

The Internet is a medium through which many electronic commerce (e-commerce) transactions can occur. These transactions can be facilitated through various types of item transaction platforms on the Internet. The transactions can include buying new and used items. These items can be physical products, software, or services.

Two types of item transaction platforms that can be used facilitate e-commerce transactions include a business to customer (B2C) platform and a customer to customer (C2C) platform. With a business to customer platform, a business can sell items to users. With a customer to customer platform, one customer can sell items to another customer. A customer to customer platform is also referred to as a person-to-person platform.

Applications are used by sellers in a customer to customer platform to offer items for purchase on the customer to customer platform. For example, a mobile app, such as a buy-sell classified mobile application, can be used by various users of the platform to buy, sell, or rent a wide range of items through the customer to customer platform. These items can include, for example, electronics, furniture, real estate properties, automobiles, artwork, toys, educational goods, tutoring, and other items.

The items can be offered through profiles that describe information about the items. A profile for an item being offered includes information about the item. The profile is an advertisement on the customer to customer platform that can be viewed by potential buyers who may be interested in the item being offered on the customer to customer platform.

### SUMMARY

According to one illustrative embodiment, a computer implemented method recommends item attributes. A computer system determines the item attributes in an item profile for an item offered by a seller on an item transaction platform. The computer system identifies interactions between the seller and a potential buyer regarding the item. The computer system determines a set of missing item attributes from the item profile based on the interactions between the seller and the potential buyer. The computer system recommends a set of actions for the set of missing item attributes identified to a seller of the item in a recommendation. The computer system performs a set of actions in the recommendation using the set of missing item attributes in response to a user input from the seller responding to the recommendation. According to other illustrative embodiments, a computer system and a computer program product for recommending item attributes are provided.

### BRIEF DESCRIPTION OF THE DRAWINGS

FIG. 1 is a block diagram of a computing environment in which illustrative embodiments can be implemented;

FIG. 2 is a pictorial representation of a network of data processing systems in which illustrative embodiments may be implemented;

FIG. 3 is a block diagram of an item transaction environment in accordance with an illustrative embodiment;

FIG. 4 is a flowchart of a process for performing a set of actions using a set of missing item attributes in response to a user input in accordance with an illustrative embodiment;

FIG. 5 is a flowchart of a process for recommending a set of actions based on potential buyers identified for the items in accordance with an illustrative embodiment;

FIG. 6 is a flowchart of a process for recommending a set of missing item attributes based on seller constraints in accordance with an illustrative embodiment;

FIG. 7 is a flowchart of a process for recommending a set of transaction attributes in accordance with an illustrative embodiment;

FIG. 8 is a flowchart of a process for determining a set of transaction attributes for an item transaction for an item in accordance with an illustrative embodiment;

FIG. 9 is a flowchart of a process for determining a set of transaction attributes for an item transaction for an item in accordance with an illustrative embodiment;

FIG. 10 is a flowchart of a process for sending information about a missing item attribute to another potential buyer in accordance with an illustrative embodiment;

FIG. 11 is a flowchart of a process for interacting with potential buyers in accordance with an illustrative embodiment;

FIG. 12 is a flowchart of a process for managing item attributes for items in accordance with an illustrative embodiment; and

FIG. 13 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved item management code 190. In the illustrative examples, improved item management code 190 can be used to manage profiles in item transaction platforms and interactions between users the item transaction platforms. In addition to improved item management code 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and improved item management code 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

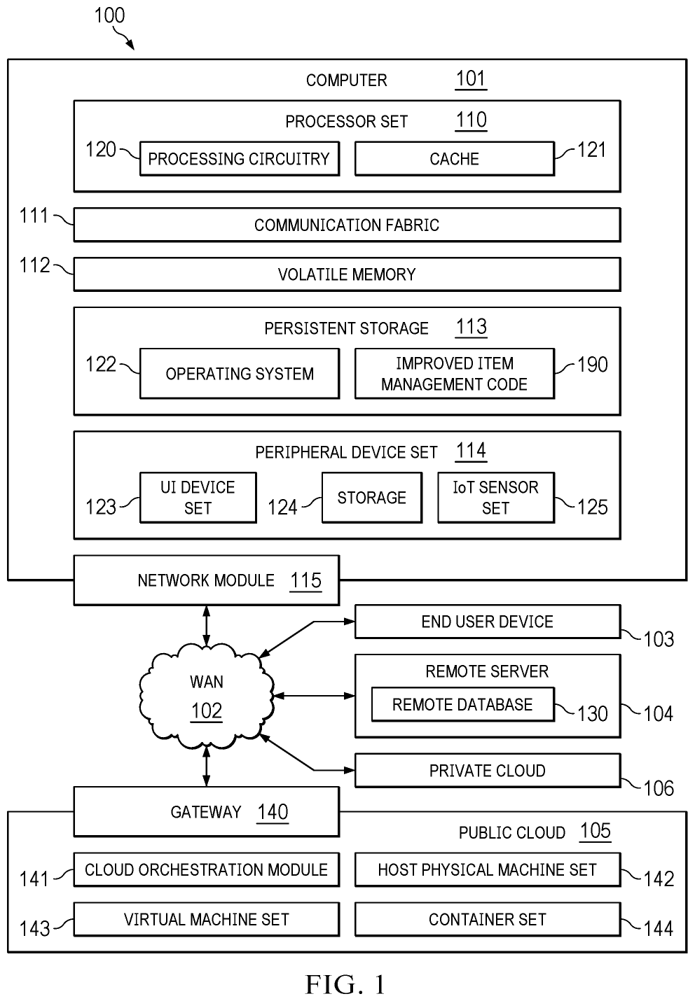

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in improved item management code 190 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in improved item management code 190 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. For example, the illustrative embodiments recognize and take into account that the sellers using a customer to customer platform are more often general sellers rather than experienced or professional sellers.

In offering an item for purchase on a customer to customer platform, sellers generate details about the items being offered. These details are item attributes about the items. These item attributes can include, for example, information about size, dimensions, weight, reliability, capabilities, functionality, price, and other information about the item being offered on the customer to customer platform. Inexperienced sellers offering items on a customer to customer platform may fail to update details or provide sufficient details about the item when creating advertisement to offer the item to potential buyers.

Additionally, these customer to customer platforms enable interactions between sellers and potential buyers. These interactions are communications that can be facilitated by the customer to customer platforms. As a result, in an interaction between potential buyers and sellers, the potential buyers can send communications with questions to the sellers regarding missing details. A seller can interact with the potential buyer by providing responses to potential buyers.

However, the seller may fail to update the advertisement for the product with the missing details provided in responses to the buyers. As a result, the same questions may be repeated from other potential buyers, increasing the time and frustration to the seller. Further, sales of items may be lost or delayed because of incomplete details.

With this situation, the lack of details desired by a potential buyer may make the potential buyer feel like time is being lost on reviewing the advertisement or the product and trust may be reduced. As a result, the potential by may look at other options from other sellers. Additionally, multiple communications may result in delayed realization of fees charged by the customer to customer platform for completed transactions.

It would be desirable to have a method, apparatus, system, and computer program product that solves the problems that the lack of details on a customer to customer platform cause sellers and potential buyers as well as solving a problem for delayed realization of fees for the customer to customer platform. The illustrative examples provide a cognitive approach to detect and determine missing details in an advertisement for items posted by sellers. The illustrative example can generate recommendations to the sellers based on the analysis performed using the cognitive approach.

Thus, the illustrative embodiments provide a computer implemented method, apparatus, system, and computer program product for recommending item attributes. These item attributes provide information about an item being offered on an item transaction platform such as a customer to customer platform.

In one illustrative example, a computer system determines the item attributes in an item profile for an item offered by a seller on an item transaction platform. The computer system identifies interactions between the seller and a potential buyer regarding the item. The computer system determines a set of missing item attributes from the item profile based on the interactions between the seller and the potential buyer. The computer system recommends a set of actions based on the set of missing item attributes identified to a seller of the item in a recommendation. The computer system performs a set of actions in the recommendation using the set of missing item attributes in response to a user input from the seller responding to the recommendation.

As used herein, a “set of” when used with reference to items means one or more items. For example, a set of missing item attributes is one or more missing item attributes.

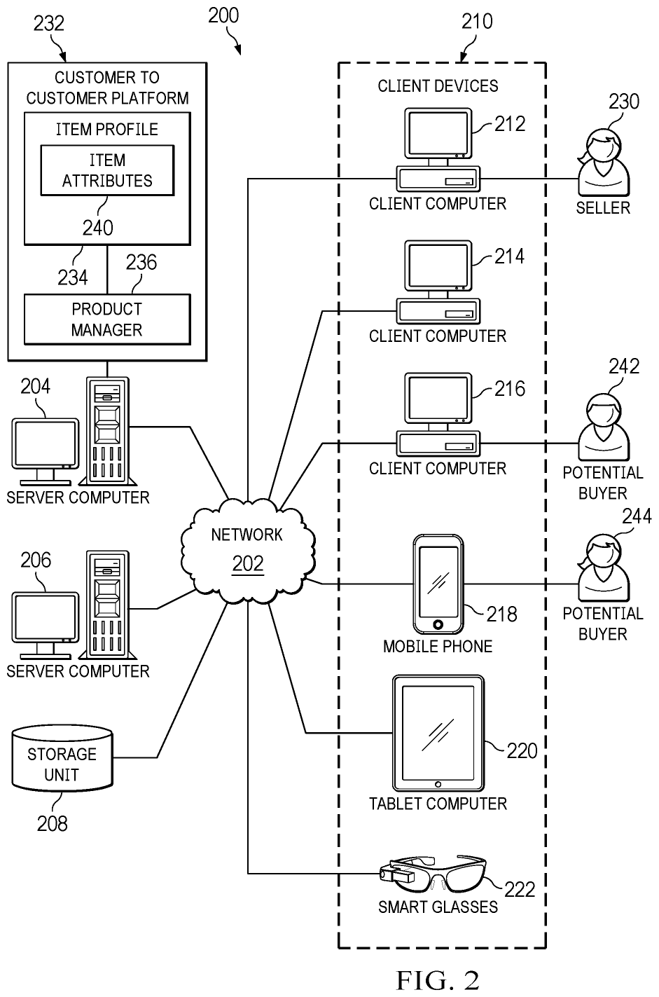

With reference now to FIG. 2, a pictorial representation of a network of data processing systems is depicted in which illustrative embodiments may be implemented. Network data processing system 200 is a network of computers in which the illustrative embodiments may be implemented. Network data processing system 200 contains network 202, which is the medium used to provide communications links between various devices and computers connected together within network data processing system 200. Network 202 can include connections, such as wire, wireless communication links, or fiber optic cables.

In the depicted example, server computer 204 and server computer 206 connect to network 202 along with storage unit 208. In addition, client devices 210 connect to network 202. As depicted, client devices 210 include client computer 212, client computer 214, and client computer 216. Client devices 210 can be, for example, computers, workstations, or network computers. In the depicted example, server computer 204 provides information, such as boot files, operating system images, and applications to client devices 210. Further, client devices 210 can also include other types of client devices such as mobile phone 218, tablet computer 220, and smart glasses 222. In this illustrative example, server computer 204, server computer 206, storage unit 208, and client devices 210 are network devices that connect to network 202 in which network 202 is the communications media for these network devices. Some or all of client devices 210 may form an Internet of things (IoT) in which these physical devices can connect to network 202 and exchange information with each other over network 202.

Client devices 210 are clients to server computer 204 in this example. Network data processing system 200 may include additional server computers, client computers, and other devices not shown. Client devices 210 connect to network 202 utilizing at least one of wired, optical fiber, or wireless connections.

Program instructions located in network data processing system 200 can be stored on a computer-recordable storage media and downloaded to a data processing system or other device for use. For example, program instructions can be stored on a computer-recordable storage media on server computer 204 and downloaded to client devices 210 over network 202 for use on client devices 210.

In the depicted example, network data processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 200 also may be implemented using a number of different types of networks. For example, network 202 can be comprised of at least one of the Internet, an intranet, a local area network (LAN), a metropolitan area network (MAN), or a wide area network (WAN). FIG. 2 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In this illustrative example, seller 230 can use customer to customer platform 232 to offer items such as products or services for sale to potential buyers. Customer to customer platform can be implemented as a website. An example of a customer to customer platform 232 is eBay by eBay Inc.

In this depicted example, seller 230 offers a smart phone for sale on customer to customer platform 232. Seller 230 generates item profile 234 by interacting with product manager 236 in customer to customer platform 232 using client computer 212. Item profile 234 is an advertisement for the smart phone that comprises item attributes 240 that provide details about the smart phone. In this illustrative example, item attributes 240 for the smart phone includes model, processor, screen size, dimensions, weight, and price.

Potential buyers, such as potential buyer 242 at client computer 216 and potential buyer 244 at mobile phone 218, can view item profile 234 as well as other item profiles on customer to customer platform 232. In this illustrative example, item attributes 240 in item profile 234 may be missing some details that potential buyer 242 wants to know in considering purchasing the mobile phone.

In this case, potential buyer 242 can interact with seller 230. The interaction can take the form of communications between potential buyer 242 and seller 230. Customer to customer platform 232 provides communications features such as chat and email that can provide seamless communication for users of customer to customer platform 232.

For example, potential buyer 242 can interact with seller 230 by sending an email message through customer to customer platform 232 to seller 230 asking about storage capacity of the mobile phone. This detail about the storage capacity is missing from item attributes 240. Seller 230 can interact with potential buyer 242 by sending an email response with the details of the storage capacity for the mobile phone.

In this illustrative example, product manager 236 monitors the interaction between seller 230 and potential buyer 242. In response to request for storage capacity by potential buyer 242 and the response with the storage capacity of the mobile phone by seller 230, product manager 236 recommends a set of actions for the attribute of storage capacity missing from item attributes 240 in item profile 234. For example, product manager 236 can recommend adding this missing item attribute to item attributes 240 in item profile 234 in response to user input from seller 230 to add the missing item attribute.

As a result, when potential buyer 244 views item profile 234, potential buyer 244 sees the storage capacity along with other item attributes in item profile 234. When potential buyer 244 is interested in storage capacity, potential buyer 244 does not need to interact with seller 230 because the storage capacity is present in item attributes 240 for item profile 234 as updated by product manager 236.

As a result, seller 230 receives less questions and has reduced potential frustration with using customer to customer platform 232. Further, other potential buyers may not feel like they are wasting time reviewing item profile 234 because of missing item attributes about the smartphone. Additionally, potential buyers losing trust in seller 230 and looking to other options from other sellers can be reduced.

Further, product manager 236 can recommend other actions with respect to missing item attributes identified for product profiles on customer to customer platform 232. Other recommendations can include, for example, sending the missing item attributes to potential buyers requesting the missing item attributes without seller interaction, sending the missing item attributes to other potential buyers of identified products, performing automatic product profile updates, and other suitable actions based on interactions between the sellers and potential buyers.

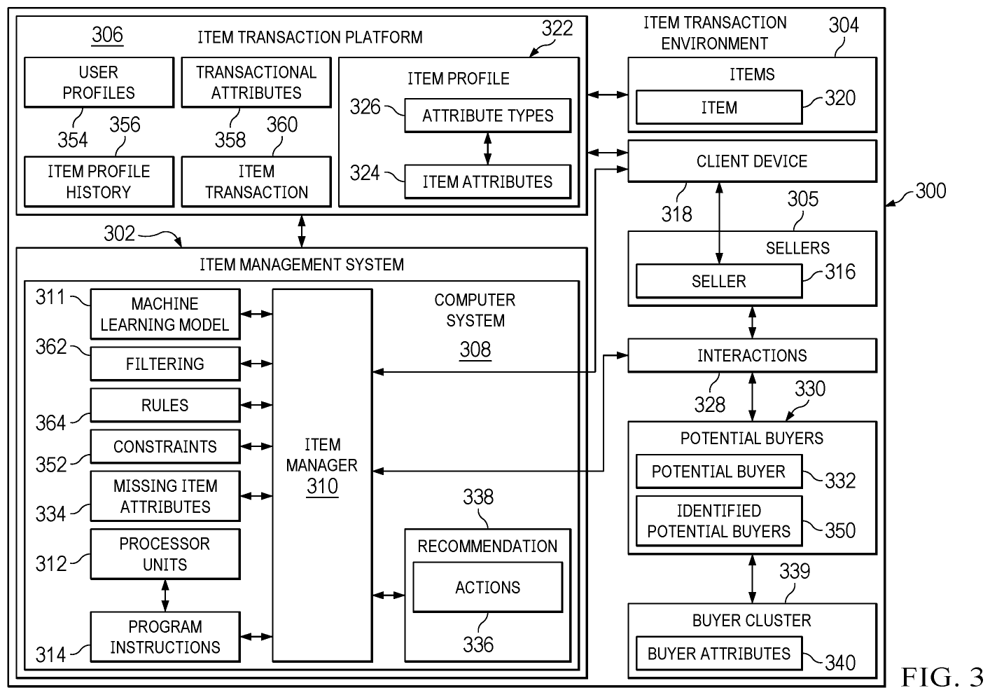

With reference now to FIG. 3, a block diagram of an item transaction environment is depicted in accordance with an illustrative embodiment. In this illustrative example, item transaction environment 300 includes components that can be implemented in hardware such as the hardware shown in network data processing system 200 in FIG. 2.

As depicted item management system 302 in item transaction environment 300 of can be used to manage information about items 304 offered buy sellers 305 on item transaction platform 306. In this illustrative example, item transaction platform 306 is comprised of at least one of software and underlying hardware to offer items 304 for purchase on a network such as the Internet. Item transaction platform 306 can be, for example, a customer to customer (C2C) platform, a business to customer (B2C) platform, or some other platform or system that offers items for sale by one party to another party. Customer to customer platform 232 in FIG. 2 is an example of an implementation for item transaction platform 306.

Items 304 can take a number of different forms. For example, items 304 can be tangible products, intangible products, services, software, electronics, furniture, vehicles, groceries, tools, sporting goods, lawn equipment, or other types of items that can be sold.

In this illustrative example, item management system 302 comprises computer system 308 and item manager 310. Item manager 310 is located in computer system 308. Product manager 236 in FIG. 2 is an example of an implementation for item manager 310.

Item manager 310 can be implemented in software, hardware, firmware or a combination thereof. When software is used, the operations performed by item manager 310 can be implemented in program instructions configured to run on hardware, such as a processor unit. When firmware is used, the operations performed by item manager 310 can be implemented in program instructions and data and stored in persistent memory to run on a processor unit. When hardware is employed, the hardware can include circuits that operate to perform the operations in item manager 310.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 308 is a physical hardware system and includes one or more data processing systems. When more than one data processing system is present in computer system 308, those data processing systems are in communication with each other using a communications medium. The communications medium can be a network. The data processing systems can be selected from at least one of a computer, a server computer, a tablet computer, or some other suitable data processing system.

As depicted, computer system 308 includes a number of processor units 312 that are capable of executing program instructions 314 implementing processes in the illustrative examples. As used herein a processor unit in the number of processor units 312 is a hardware device and is comprised of hardware circuits such as those on an integrated circuit that respond and process instructions and program instructions that operate a computer. When a number of processor units 312 execute program instructions 314 for a process, the number of processor units 312 is one or more processor units that can be on the same computer or on different computers. In other words, the process can be distributed between processor units on the same or different computers in a computer system. Further, the number of processor units 312 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, seller 316 at client device 318 offers item 320 in items 304 for sale on item transaction platform 306. For example, seller 316 can create item profile 322 for item 320 on item transaction platform 306. Item profile 322 describes item 320 using item attributes 324.

As depicted, item attributes 324 have attribute types 326. Attribute types 326 can be selected from at least one of text, and image, a video, or other forms of media for information describing item 320. Item attributes 324 can be, for example, model, item dimensions, weight, color, brand, connectivity, resolution, display type, wireless communication technology, processor, memory, storage, operation, and other attributes that may be of interest to potential buyers considering item 320 offered on item transaction platform 306.

In this illustrative example, item manager 310 can determine item attributes 324 in item profile 322 for item 320 offered by seller 316 on item transaction platform 306. Item manager 310 can access item profiles on item transaction platform 306.

Further, item manager 310 can monitor interactions 328 between sellers 305 and potential buyers 330. Item manager 310 identifies interactions 328 between seller 316 in sellers 305 and potential buyer 332 in potential buyers 330. Interactions 328 can take place in a number of different locations.

For example, interactions 328 can be interactions facilitated by item transaction platform 306. These interactions can be at least one of chat messages, email messages, or other types of communications facilitated by item transaction platform 306. In other illustrative examples, interactions 328 can be communications made can be on social media platforms, message boards, other item transaction platforms, or other platforms where for potential buyers 330 and sellers 305 can interact. In other words, item manager 310 can also monitor for interactions between potential buyers 330; between potential buyers 330 and seller 316; between potential buyers 330 and sellers 305; or between potential buyer 332 and seller 316.

Interactions 328 can be selected from at least one of communications between seller 316 of item 320 and a set of potential buyers 330; interactions 328 between sellers 305 and potential buyers 330 regarding the set of missing item attributes 334 for items 304 of a same type as item 320 offered on item transaction platform 306; or communications on a discussion forum on an online platform discussing the set of missing item attributes 334 for item 320.

In this illustrative example, item manager 310 can determine a set of missing item attributes 334 from item profile 322 based on interactions 328 between seller 316 and potential buyer 332. Item manager 310 recommends a set of actions 336 for the set of missing item attributes 334 to seller 316 of item 320 in recommendation 338. The set of actions 336 can take a number of different forms. For example, without limitation, the set of actions 336 can be selected from at least one of updating item profile 322 with the set of missing item attributes 334, sending a response to an interaction from another potential buyer requesting the set of missing item attributes 334, sending the set of missing item attributes 334 to a set of potential buyers 330 in a same buyer cluster as potential buyer 332.

In this example, buyer cluster 339 is a grouping of potential buyers 330. Buyer cluster 339 can also be referred to as a class of potential buyers 330. The grouping of potential buyers 330 can be based on buyer attributes 340 for potential buyers 330. These buyer attributes 340 can be, for example, geographic location, compensation, interests, age, occupation, or other attributes for potential buyers 330.

In another illustrative example, item manager 310 can determine potential buyers 330 for item 320 to form identified potential buyers 350. Potential buyers 330 for item 320 can be identified any number of different ways. For example, interactions between potential buyers 330 discussing item 320 can be the basis for identifying those potential buyers as identified potential buyers 350.

Identified potential buyers 350 can be identified from at least one of one of a database, historical transaction data from item transaction platform 306, publicly available information, social media, or other sources that can be accessed by item manager 310. In this illustrative example, these various sources of information about potential buyers 330 can be obtained in a number of different ways. For example, item manager 310 can make requests to item transaction platform 306 to obtain transaction information. As another example, web crawlers can be used to obtain information from forms and websites.

In one example, forums on the Internet include interactions in the form discussions of a particular television model. In these discussions, 75% of the discussions mentioned the desirability of a super active matrix organic light emitting diodes (AMOLED) display for that particular television model. Potential buyers 330 involved in those discussions are identified potential buyers 350. In this illustrative example, details of a super AMOLED display are absent from item attributes for the particular television model. The super AMOLED display is a missing item attribute in this example.

In another example, 70% of the people belong to a 20 to 30 years age group on social media platform. Discussions in this age group specify details of camera sensors for digital cameras. In this example, identified potential buyers 350 are potential buyers 330 in the 20 to 30 years age group. Details of the camera sensor are absent from the camera being offered item transaction platform 306. The item attribute of the camera sensor is a missing item attribute for the digital camera.

Item manager 310 can determine the set of missing item attributes 334 based on identified potential buyers 350 and interactions 328 between identified potential buyers 350. Item manager 310 can then recommend the set of actions 336 for the set of missing item attributes 334 identified for identified potential buyers 350 to seller 316 of item 320 in recommendation 338.

Further, item manager 310 can take into account other factors in determining which ones of missing item attributes 334 should be recommended for item profile 322 when missing item attributes 334 identified. For example, item manager 310 can determine a set of constraints 352 on item attributes 324 for seller 316 of item 320. In determining the set of constraints 352, item manager 310 can take into account constraints of seller 316 or sellers 305 in the same cluster as seller 316. With the determination of the set of constraints 352, item manager 310 can recommend the set of missing item attributes 334 based on interactions 328 of seller 316 with potential buyers 330 and set of constraints 352.

The set of constraints 352 can be determined in a number of different ways. For example, item manager 310 can identify the set of constraints 352 using user profiles 354 for seller 316. User profiles 354 can include profiles for sellers 305 and potential buyers 330 that have registered with item transaction platform 306.

For example, item manager 310 can also make the recommendation based on other similar sellers in the same seller cluster. For example, a cluster for sellers 305 can be photographers. In this example, 90% of the photographers selling cameras did not mention a graphics processor unit (GPU) in the item attributes used in item profiles. When seller 316 generates item profile 322 and does not include information about a GPU in item attributes 324, item manager 310 does not identify an item attribute as a missing item attribute in response to a request from potential buyer 332 for information about the GPU in an interaction between seller 316 and potential buyer 332.

As another example, item manager 310 can analyze item profile history 356 to identify a history of item profiles generated by seller 316. For example, if the seller history indicates that seller 316 has never included price in previous item profiles and seller 316 has not included price in item attributes 324 for item profile 322, then item manager 310 does not recommend adding price to item attributes 324. This recommendation is made by item manager 310 even though price may be considered a missing item attribute based on a request from potential buyer 332 for the price.

In yet another example, the set of constraints 352 on item attributes 324 to be recommended when missing item attributes 334 can identified using publicly available information. For example, information can be obtained from the Internet about whether sellers of the same type of item 320 are inclined to include a particular item attribute in when generating item profiles for item transaction platforms. For example, other sellers may not mention the condition of brakes for bicycles. As a result, when item 320 is a bicycle and potential buyer 332 requests information from seller 316 for the condition of brakes which are not included item attributes 324 in item profile 322, item manager 310 does not recommend this missing item attribute to be added to item profile 322.

Further, item manager 310 can also recommend a set of transactional attributes 358 for item transaction 360 for item 320. The determination of the set of transactional attributes 358 can be made in a number of different ways. For example, item manager 310 can determine the set of transactional attributes 358 for item transaction 360 for items 304 based on a configuration of item transaction platform 306. The configuration can be selected from at least one of a fulfillment method, a payment method, or other configuration for item transaction platform 306.

The payment method as a transaction attribute can be based on payment methods supported by item transaction platform 306. In another illustrative example, the manner in which items are shipped or delivered can be specified by item transaction platform 306.

In still another illustrative example, item manager 310 can determine the set of transactional attributes 358 for item transaction 360 for items 304 based on information about seller 316 and potential buyer 332. This information can be selected from at least one of calendar information, payment options, or other information about seller 316 and potential buyer 332. In this example, calendars for seller 316 and potential buyer 332 can be used to recommend a transaction attribute such as a location and date for a demonstration that is convenient for both seller 316 and potential buyer 332. Open timeslots, preferred locations, or other information from calendars can be used to schedule a time and place for a demonstration or delivery of an item.

As another illustrative example, a transactional attribute such as a payment method can be recommended that is used by both seller 316 and potential buyer 332. For example, if seller 316 and potential buyer 332 both use payment service A, then payment service A can be recommended as a transaction attribute for facilitating payment in item transaction 360 for item 320.

In yet another illustrative example, item manager 310 can perform filtering 362 on item attributes 324 using a set of rules 364. The set of rules 364 can be created based on interactions between sellers 305 and potential buyers 330. Further, the fixed filtering rules can be generated for seller 316 based on interactions of seller 316 with potential buyers 330. For example, the filtering 362 may ensure that personally identifiable information is absent from item attributes 324. For example, filtering 362 item attributes 324 having an attribute type of an image filters the image to not include faces of people. In another example, filtering 362 on images or other information for item attributes 324 can be performed to ensure that other personally identifiable information such as home address, phone number, or other information is not present in item attributes 324 in item profile 322.

Further, the set of rules 364 can also include rules regarding sending information about missing item attributes to potential buyers 330. For example, item manager 310 can detect an interaction between seller 316 and potential buyer 332 in which seller 316 responds to a request for a missing item attribute by sending the missing item attribute to potential buyer 332.

The set of rules 364 can indicate that seller 316 allows for automatic sending of a missing item attribute based on interactions in which seller 316 response providing a missing item attribute to a potential buyer. With this rule, item manager 310 can send information about the same missing item attribute to another potential buyer based on a set of rules 364 in response to an interaction from that potential buyer requesting the missing item attribute. The set of rules 364 can indicate which potential buyers can receive missing item attributes 334 when making requests for missing item attributes 334 without using seller 316 interaction to respond to those potential buyers.

In illustrative example, the different analysis, determinations, and identifications made by item manager 310 can be made using machine learning model 311. Machine learning model 311 is a type of artificial intelligence model that can learn without being explicitly programmed. Machine learning model 311 can learn based training data input into the machine learning model. The machine learning model can learn using various types of machine learning algorithms. The machine learning algorithms include at least one of a supervised learning, and unsupervised learning, a feature learning, a sparse dictionary learning, an anomaly detection, a reinforcement learning, a recommendation learning, or other types of learning algorithms.

Examples of machine learning models include an artificial neural network, a convolutional neural network, a decision tree, a support vector machine, a regression machine learning model, a classification machine learning model, a random forest learning model, a Bayesian network, a genetic algorithm, and other types of models. These machine learning models can be trained using data and process additional data to provide a desired output.

For example, machine learning model 311 can determine at least one of missing item attributes 334, constraints 352, transactional attributes 358. For example, machine learning model 311 can be trained using historical interactions to analyze interactions 328 such as email messages, chat messages, and other types of communications. In another illustrative example, machine learning model 311 can analyze user profiles 354 and item profile history 356 to determine constraints 352. Further, machine learning model 311 can identify actions 336 to make recommendation 338.

In yet other illustrative examples, item manager 310 can perform actions 336 to make recommendations for actions 336 using rules 364. In this example, item manager 310 can operate using a rule-based mechanism without using machine learning model 311.

In the illustrative example, the use of item manager 310 in computer system 308 integrates processes into a practical application for a method that manages item profiles on an in item transaction platform that reduces the use of resources by item transaction platform 306. In one illustrative example, item manager 310 in computer system 308 is directed to a practical application of processes integrated into item manager 310 in computer system 308 that recommends item attributes in an item profile offered by seller on an item transaction platform. In the illustrative example, the recommending of item attributes is performed in a manner that reduces the need for a seller to respond to each request for an attribute that may be missing from an item profile.

In the depicted example, a seller does not need to read each communication from a potential buyer about the same missing item attribute and send an email in response to each one communication. Instead, item manager 310 can recommend changes to item attributes in item profile to include missing item attributes such that the amount of interaction between sellers and potential buyers on an item transaction platform can be reduced. One result of this application of the process in item manager 310 in computer system 308 is a reduction in network traffic and bandwidth use by item transaction platform can be reduced.

The illustration of item transaction environment 300 in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, item management system 302 is shown as a separate component from item transaction platform 306. In other illustrative examples, item management system 302 can be implemented as part of item transaction platform 306. In still other illustrative examples, item management system 302 can determine recommendations for one or more item transaction platforms in addition to or in place of item transaction platform 306.

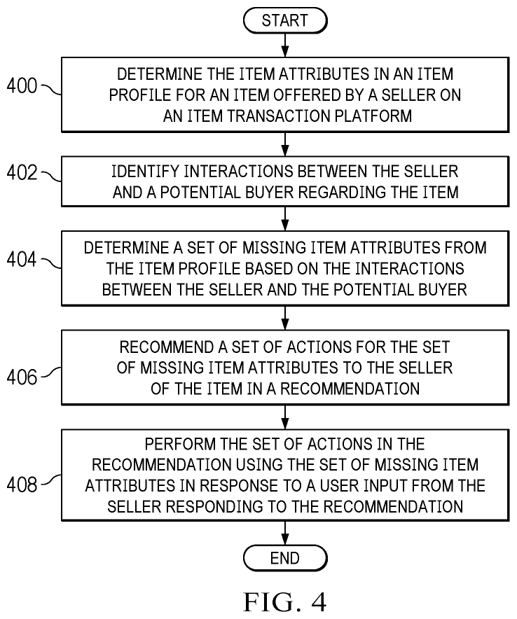

With reference to FIG. 4, a flowchart of a process for performing a set of actions using a set of missing item attributes in response to a user input is depicted in accordance with an illustrative embodiment. The process illustrated in FIG. 4 can be implemented using computer system 308 in FIG. 3. For example, the process can be implemented in item manager 310 in computer system 308 in FIG. 3.

The process begins by determining the item attributes in an item profile for an item offered by a seller on an item transaction platform (step 400). The process identifies interactions between the seller and a potential buyer regarding the item (step 402). The process determines a set of missing item attributes from the item profile based on the interactions between the seller and the potential buyer (step 404). The process recommends a set of actions for the set of missing item attributes to a seller of the item in a recommendation (step 406). The process performs the set of actions in the recommendation using the set of missing item attributes in response to a user input from the seller responding to the recommendation (step 408). The process terminates thereafter.

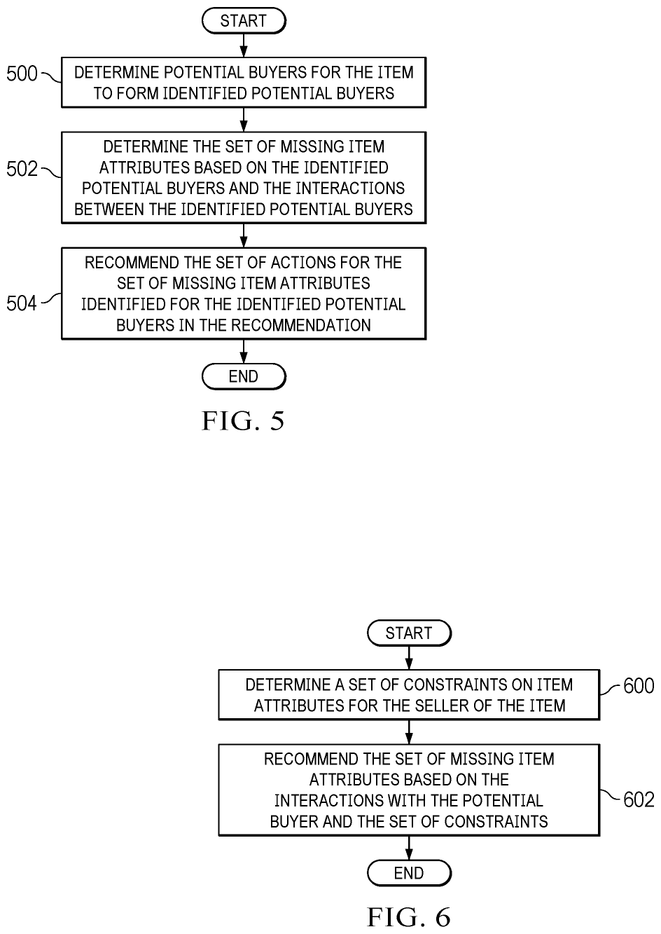

Turning next to FIG. 5, a flowchart of a process for recommending a set of actions based on potential buyers identified for the items is depicted in accordance with an illustrative embodiment. The steps illustrated in FIG. 5 are examples of additional steps that can be used with the steps in the process in FIG. 4.

The process begins by determining potential buyers for the item to form identified potential buyers (step 500). In step 500, the process identifies potential buyers that may not have interacted with seller. The process determines the set of missing item attributes based on the identified potential buyers and the interactions between the identified potential buyers (step 502). These interactions between the identified potential buyers occur on the item transaction platform, or some external platform. An external platform can be, for example, another item transaction platform, social media network, a form, or other platform through which potential buyers can communicate.

The process recommends the set of actions for the set of missing item attributes identified for the identified potential buyers in the recommendation (step 504). The process terminates thereafter.

With reference to FIG. 6, a flowchart of a process for recommending a set of missing item attributes based on seller constraints is depicted in accordance with an illustrative embodiment. The steps illustrated in FIG. 6 are examples of additional steps that can be used with the steps in the process in FIG. 4.

The process begins by determining a set of constraints on item attributes for the seller of the item (step 600). The process recommends the set of missing item attributes based on the interactions with the potential buyer and the set of constraints (step 602). The process terminates thereafter.

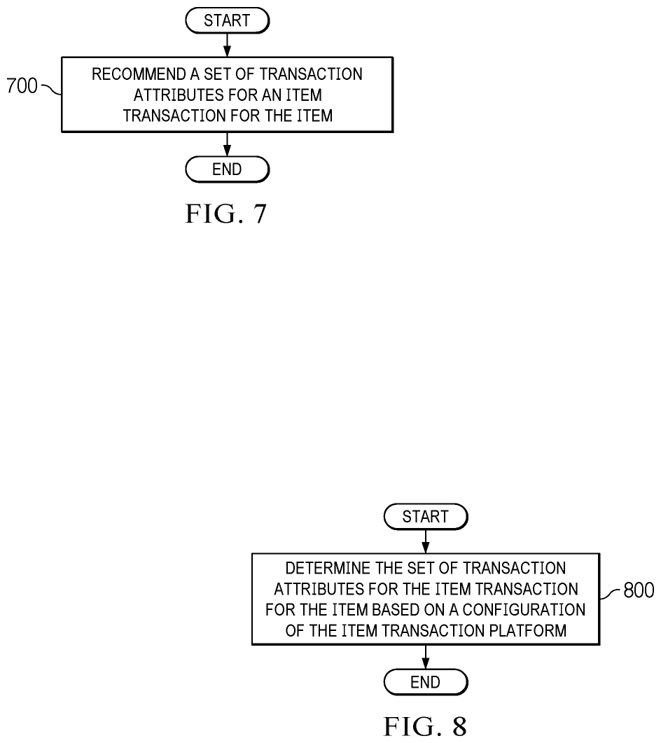

With reference now to FIG. 7, a flowchart of a process for recommending a set of transaction attributes is depicted in accordance with an illustrative embodiment. The step in FIG. 7 is an example of an additional step that can be used with the steps in the process in FIG. 4. The process recommends a set of transaction attributes for an item transaction for the item (step 700). The process terminates thereafter.

Turning next to FIG. 8, a flowchart of a process for determining a set of transaction attributes for an item transaction for an item is depicted in accordance with an illustrative embodiment. The step in FIG. 8 is an example of an additional step that can be used with the step in the process in FIG. 7.

The process determines the set of transaction attributes for the item transaction for the item based on a configuration of the item transaction platform (step 800). The process terminates thereafter.

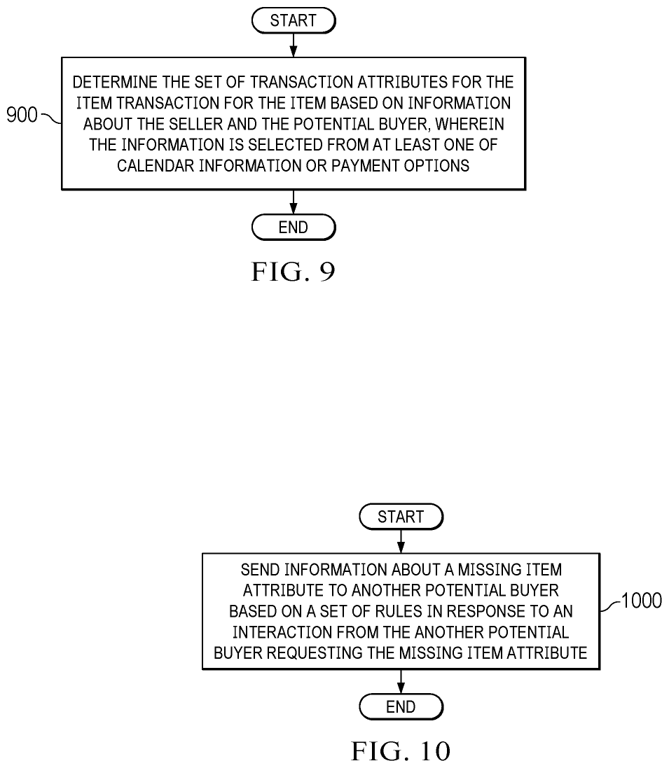

Turning to FIG. 9, a flowchart of a process for determining a set of transaction attributes for an item transaction for an item is depicted in accordance with an illustrative embodiment. The step in FIG. 9 is an example of an additional step that can be used with the step in the process in FIG. 7.

The process determines the set of transaction attributes for the item transaction for the item based on information about the seller and the potential buyer, wherein the information is selected from at least one of calendar information or payment options (step 900). The process terminates thereafter.

With reference to FIG. 10, a flowchart of a process for sending information about a missing item attribute to another potential buyer is depicted in accordance with an illustrative embodiment. The step in FIG. 10 is an example of an additional step that can be used with the steps in the process in FIG. 4.

The process sends information about a missing item attribute to another potential buyer based on a set of rules in response to an interaction from another potential buyer requesting the missing item attribute (step 1000). The process terminates thereafter.

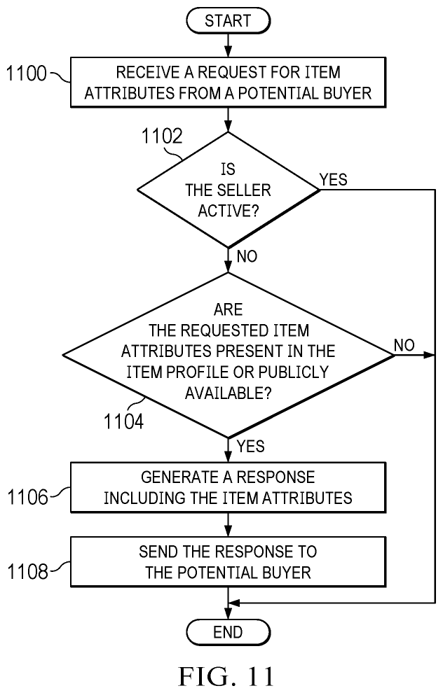

Turning next to FIG. 11, a flowchart of a process for interacting with potential buyers is depicted in accordance with an illustrative embodiment. The process in FIG. 11 can be implemented in hardware, software, or both. When implemented in software, the process can take the form of program instructions that is run by one of more processor units located in one or more hardware devices in one or more computer systems. For example, the process can be implemented in item manager 310 in computer system 308 in FIG. 3.

The process begins by receiving a request for item attributes from a potential buyer (step 1100). The process determines whether the seller is active (step 1102). In step 1102, the seller is not considered to be active when the seller is not online on the item transaction platform.

In response to the seller not being active, the process determines whether the requested item attributes are present in the item profile or publicly available (step 1104). In this example, item attributes can be publicly available when those item attributes for an item can be found on the Internet such as on a product website, catalog, or some of the publicly available location. The process generates a response including the item attributes when the item attributes are present in the item profile or publicly available (step 1106). The process sends the response to the potential buyer (step 1108). The process terminates thereafter.

With reference again to step 1104, if the requested item attributes are not present the item profile or publicly available, the process terminates. In this case, the process waits for the seller to respond to the request. With reference again to step 1102, if the seller is active, the process terminates. In this case, the process waits for the seller to respond to the request.

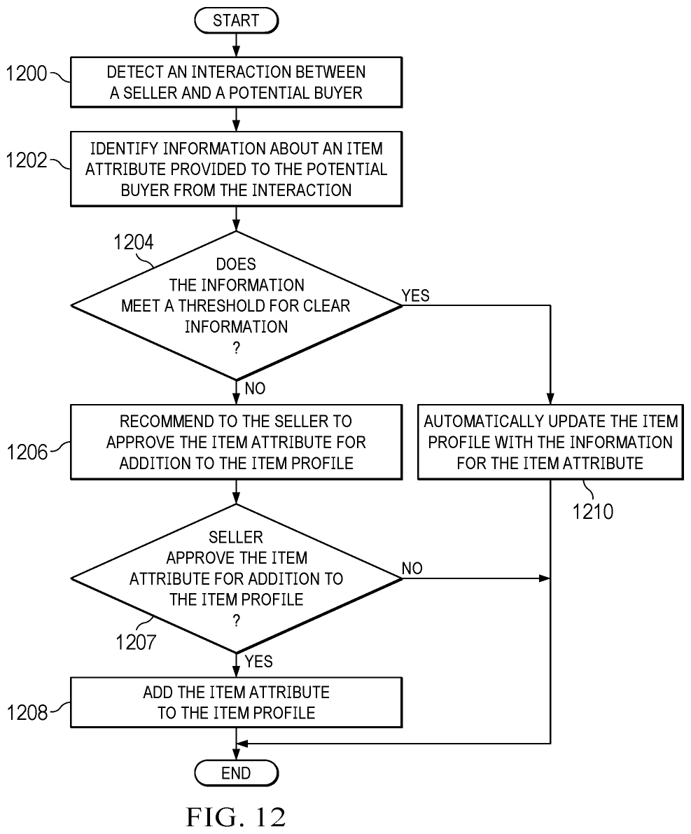

Turning to FIG. 12, a flowchart of a process for managing item attributes for items is depicted in accordance with an illustrative embodiment. The process in FIG. 12 can be implemented in hardware, software, or both. When implemented in software, the process can take the form of program instructions that is run by one of more processor units located in one or more hardware devices in one or more computer systems. For example, the process can be implemented in item manager 310 in computer system 308 in FIG. 3.

The process begins by detecting an interaction between a seller and a potential buyer (step 1200). The process identifies information about an item attribute provided to the potential buyer from the interaction (step 1202). The process determines whether the information meets a threshold for clear information (step 1204). In step 1204, this threshold can be used to determine whether the information about the item attribute can be automatically added to the item profile. A score on how clear the information is for the item attribute can be determined from processing the communication. The processing of the communication determines how clear the answer was to the request for information about the item attributes. Natural language processing and other semantic techniques can be used to understand messages and determine the how clear the answer is and provide a score. For example, a determination can made as to how tentative, certain, or indefinite the seller was in the communication about the item attributes.

If the information does not meet the threshold for clear indication, the process recommends to the seller to approve the item attribute for addition to the item profile (step 1206). A determination is made as to whether the seller approves the item attribute for addition to the item profile (step 1207). If the seller does not approve the recommendation, the process terminates.

Otherwise, the process adds the item attribute to the item profile (step 1208). The process terminates thereafter. With reference again to step 1204, if the information about the item attribute meets a threshold for clear information, the process automatically updates the item profile with the information for the item attribute (step 1210). The process terminates thereafter. When the information about item attribute is approved by the seller or meets the threshold for clear information, the process can automatically respond in future interactions that request information about the item attribute.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

Item manager 310 in item management system 302 can facilitate interactions 328 between sellers 305, potential buyers 330, and items 304 offered for sale on item transaction platform 306. A number of different examples described below illustrate scenarios in which item manager 310 can provide a practical application of managing item attributes, transactional attributes, and interactions for sellers 305 and potential buyers 330.

### Example 1—Image Recommendations

In one illustrative example, the seller creates an item profile for a car on an item transaction platform in the form of an e-commerce website for an online marketplace to buy and sell automobiles. In this example, the seller uploads only one image, which is front view of the car. Other attribute information such as mileage, color, engine, model, make, and price are also included in the item profile for the car.

In this example, the seller has interactions from multiple potential buyers that request additional images with different views of the car. The seller sends the additional images in chat with a potential buyer. These additional images include image 1 for a rearview, image 2 for a driver side view, and image 3 for a passenger side view.

In this illustrative example, item manager 310 can analyze the 3 images from the interaction between the seller and the potential buyer for providing a recommendation to the seller to include those images in the item profile for the car.

In this depicted example, item manager 310 identifies a person sitting in the car in image 3. Item manager 310 can send a message to the seller as follows: “Including these images in your profile might expedite the sale. While we find image 1 and image 2 ready to be included, image 3 has a picture of person. Click Include All button to include all 3 images in the profile, click Include Recommendations button to include only image 1 and image 2 in the car profile and Click No Thanks button to keep the profile in its current form”.

In this example, the seller selects the “Include Recommendations” option. In response to this user input from the seller, item manager 310 updates the item profile to include image 1 and image 2. Item manager 310 also updates the other open interactions between the seller and other potential buyers with the inclusion of image 1 and image 2. In other words, item manager 310 can send communications with the images of the car to those other potential buyers for which responses have not been sent.

As a result, the seller does not need to initiate interactions to respond to other requests for additional images with item manager 310 interacting with potential buyers on open interactions. Additionally, future interactions requesting the same types of images can be avoided with the update to the item profile for the car. In this manner, the seller saves time as well as efforts to update the item profile at the same time.

### Example 2—Text Recommendation

In this illustrative example, the seller creates an item profile for a laptop on an item transaction platform. The seller has missed updating item attributes for product specification and features in the item profile for the laptop. In this illustrative example, the seller has interactions with potential buyers in which the potential buyers request item attributes for missing specification and features about the laptop. These specifications and features include processor speed, memory size, and wireless capabilities. In response, the seller interacts with one or more potential buyers by providing item attributes for product specification and features.

In the illustrative example, item manager 310 can automatically update item attributes in the item profile for the laptop. Additionally, item manager 310 also sends the response to other potential buyers in interactions requesting the information saying that the seller already updated item profile of the laptop.

As a result, the seller does not need to update item attributes in the item profile for the laptop to include the product specifications and features requested. Additionally, in this example, the seller does not need to respond to interactions posing the same question requesting item attributes for product specifications and features. The seller saves time as well as efforts to update the item profile for the laptop and the time needed to respond to interactions with duplicate questions from potential buyers.

### Example 3—Offer/Service Recommendations

In this depicted example, the seller has created an item profile for a bicycle on an item transaction platform. In this example, the seller has an interaction with a potential buyer requesting whether the seller is willing to provide a test ride or demonstration of the bicycle at a particular location. The seller interacts with the potential buyer by responding that the seller is willing to provide a demonstration of the bicycle at a location specified by the seller.

Item manager 310 can recommend updating the item profile to indicate that the seller is ready to give a demonstration of the bicycle if the location is nearby. A response to the seller provides user input to accept the recommendation from item manager 310, item manager 310 updates the item profile to indicate the willingness to provide a demonstration. In this example, item manager 310 can interact with other potential buyers that have requested demonstrations of the bicycle to indicate that the item profile for the bicycle has been updated with the desired information.

### Example 4—Potential Buyer Clustering Based Updates

In this illustrative example, seller in this example has created an item profile for a satellite phone. Item manager 310 identifies 2 classes of potential buyers. One class comprises boat owners and another class comprises campers. In this illustrative example, item manager 310 determines that battery performance is important for campers but not for boat owners. For boat owners, water resistance is determined to be important while battery performance is not.

In this example, item manager 310 can recommend including battery performance and water resistance to the item profile. In response to the seller returning user input accepting the recommendation, item manager 310 updates data profile for the satellite phone. In one illustrative example, item manager 310 can selectively display the item attributes for battery performance and water resistance depending on the class of the potential buyer. If another buyer asks the same question for the item, then the system automatically responds to the buyer with the updated details or the notification of the updated details.

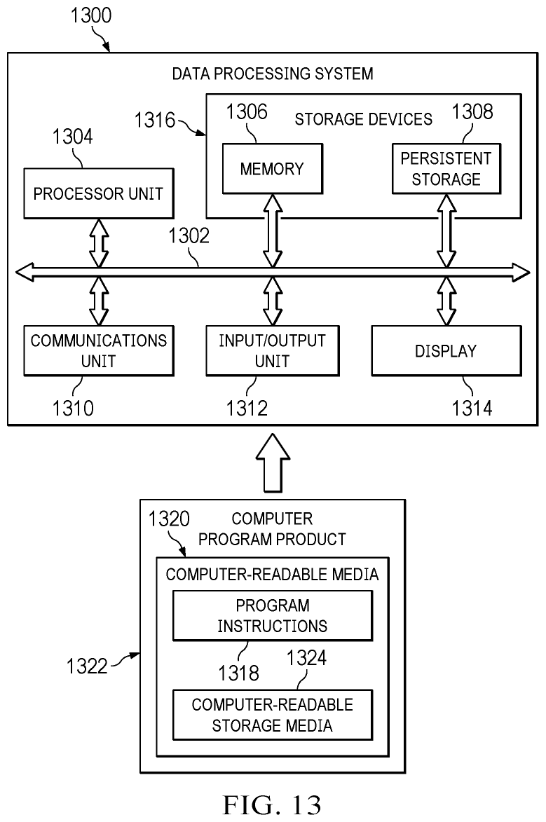

Turning now to FIG. 13, a block diagram of a data processing system is depicted in accordance with an illustrative embodiment. Data processing system 1300 can be used to implement server computer 204, server computer 206, client devices 210, in FIG. 2. Data processing system 1300 can also be used to implement computer system 308 in FIG. 3. In this illustrative example, data processing system 1300 includes communications framework 1302, which provides communications between processor unit 1304, memory 1306, persistent storage 1308, communications unit 1310, input/output unit 1312, and display 1314. In this example, communications framework 1302 takes the form of a bus system.

Processor unit 1304 serves to execute instructions for software that can be loaded into memory 1306. Processor unit 1304 includes one or more processors. For example, processor unit 1304 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1304 can may be implemented using one or more heterogeneous processor systems in which a main processor is present with secondary processors on a single chip. As another illustrative example, processor unit 1304 can be a symmetric multi-processor system containing multiple processors of the same type on a single chip.

Memory 1306 and persistent storage 1308 are examples of storage devices 1316. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1316 may also be referred to as computer-readable storage devices in these illustrative examples. Memory 1306, in these examples, can be, for example, a random-access memory or any other suitable volatile or non-volatile storage device. Persistent storage 1308 may take various forms, depending on the particular implementation.

For example, persistent storage 1308 may contain one or more components or devices. For example, persistent storage 1308 can be a hard drive, a solid-state drive (SSD), a flash memory, a rewritable optical disk, a rewritable magnetic tape, or some combination of the above. The media used by persistent storage 1308 also can be removable. For example, a removable hard drive can be used for persistent storage 1308.

Communications unit 1310, in these illustrative examples, provides for communications with other data processing systems or devices. In these illustrative examples, communications unit 1310 is a network interface card.

Input/output unit 1312 allows for input and output of data with other devices that can be connected to data processing system 1300. For example, input/output unit 1312 may provide a connection for user input through at least one of a keyboard, a mouse, or some other suitable input device. Further, input/output unit 1312 may send output to a printer. Display 1314 provides a mechanism to display information to a user.

Instructions for at least one of the operating system, applications, or programs can be located in storage devices 1316, which are in communication with processor unit 1304 through communications framework 1302. The processes of the different embodiments can be performed by processor unit 1304 using computer-implemented instructions, which may be located in a memory, such as memory 1306.

These instructions are referred to as program instructions, computer usable program instructions, or computer-readable program instructions that can be read and executed by a processor in processor unit 1304. The program instructions in the different embodiments can be embodied on different physical or computer-readable storage media, such as memory 1306 or persistent storage 1308.

Program instructions 1318 is located in a functional form on computer-readable media 1320 that is selectively removable and can be loaded onto or transferred to data processing system 1300 for execution by processor unit 1304. Program instructions 1318 and computer-readable media 1320 form computer program product 1322 in these illustrative examples. In the illustrative example, computer-readable media 1320 is computer-readable storage media 1324.

Computer-readable storage media 1324 is a physical or tangible storage device used to store program instructions 1318 rather than a medium that propagates or transmits program instructions 1318. Computer-readable storage media 1324, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1318 can be transferred to data processing system 1300 using a computer-readable signal media. The computer-readable signal media are signals and can be, for example, a propagated data signal containing program instructions 1318. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1320” can be singular or plural. For example, program instructions 1318 can be located in computer-readable media 1320 in the form of a single storage device or system. In another example, program instructions 1318 can be located in computer-readable media 1320 that is distributed in multiple data processing systems. In other words, some instructions in program instructions 1318 can be located in one data processing system while other instructions in program instructions 1318 can be located in one data processing system. For example, a portion of program instructions 1318 can be located in computer-readable media 1320 in a server computer while another portion of program instructions 1318 can be located in computer-readable media 1320 located in a set of client computers.

The different components illustrated for data processing system 1300 are not meant to provide architectural limitations to the manner in which different embodiments can be implemented. In some illustrative examples, one or more of the components may be incorporated in or otherwise form a portion of, another component. For example, memory 1306, or portions thereof, may be incorporated in processor unit 1304 in some illustrative examples. The different illustrative embodiments can be implemented in a data processing system including components in addition to or in place of those illustrated for data processing system 1300. Other components shown in FIG. 13 can be varied from the illustrative examples shown. The different embodiments can be implemented using any hardware device or system capable of running program instructions 1318.

Thus, illustrative embodiments of the present invention provide a computer implemented method, computer system, and computer program product for recommending item attributes for items being offered on an item transaction platform. In one illustrative example, a computer system determines the item attributes in an item profile for an item offered by a seller on an item transaction platform. The computer system identifies interactions between the seller and a potential buyer regarding the item. The computer system determines a set of missing item attributes from the item profile based on the interactions between the seller and the potential buyer. The computer system recommends a set of actions for the set of missing item attributes identified to a seller of the item in a recommendation. The computer system performs the set of actions in the recommendation using the set of missing item attributes in response to a user input from the seller responding to the recommendation.

As a result, the identification of missing item attributes and the recommendation on actions for those missing item attributes can reduce frustration for buyers, users, or buyers and users of item transaction platforms. In the illustrative examples, the number of interactions that a seller needs to make is reduced. For example, profiles for items can be updated with missing item attributes. Further, other buyers requesting similar missing item attributes can automatically receive responses with that information. As a result, the illustrative examples can facilitate increased transactions on item transaction platform.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, To the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

1. A computer implemented method for recommending item attributes, the computer implemented method comprising:
training, by a computer system, a machine learning model using training data comprising historical interactions and user profiles for a seller and a potential buyer;
determining, by the computer system using the machine learning model, the item attributes in an item profile for an item offered by the seller on an item transaction platform;
identifying, by the computer system using the machine learning model, interactions between the seller and the potential buyer regarding the item;
determining, by the computer system using the machine learning model, a set of missing item attributes from the item profile based on the interactions between the seller and the potential buyer;
recommending, by the computer system using the machine learning model, a set of actions that relate to the set of missing item attributes for the potential buyer to the seller of the item in a recommendation, wherein the set of actions reduce the need for the seller to respond to each request for the set of missing item attributes;
performing, by the computer system, the set of actions in the recommendation using the set of missing item attributes in response to a user input from the seller responding to the recommendation; and
automatically performing, by the computer system, the set of actions in the recommendation using the set of missing item attributes for other potential buyers to reduce network traffic and bandwidth use by the item transaction platform.

2. The computer implemented method of claim 1, wherein the set of actions is selected from at least one of updating the item profile with the set of missing item attributes, sending a response to an interaction from another potential buyer requesting the set of missing item attributes, or sending the set of missing item attributes to a set of potential buyers in a same buyer cluster as the potential buyer.

3. The computer implemented method of claim 1, wherein the interactions are selected from at least one of communications between the seller of the item and a set of potential buyers, interactions between sellers and potential buyers regarding the set of missing item attributes for items of a same type as the item offered on the item transaction platform, or communications on a discussion forum on an online platform discussing the set of missing item attributes for the item.

4. The computer implemented method of claim 1 further comprising:
determining, by the computer system, potential buyers for the item to form identified potential buyers;
determining, by the computer system, the set of missing item attributes based on the identified potential buyers and interactions between the identified potential buyers; and
recommending, by the computer system, the set of actions for the set of missing item attributes identified for the identified potential buyers in the recommendation.

5. The computer implemented method of claim 4, wherein the potential buyers are identified using at least one of a database, historical transaction data for the item transaction platform, publicly available information, or social media.

6. The computer implemented method of claim 1 further comprising:
determining, by the computer system, a set of constraints on item attributes for the seller of the item; and
recommending, by the computer system, the set of missing item attributes based on the interactions with the potential buyer and the set of constraints.

7. The computer implemented method of claim 1 further comprising:
recommending, by the computer system, a set of transaction attributes for an item transaction for the item.

8. The computer implemented method of claim 7 further comprising:
determining, by the computer system, the set of transaction attributes for the item transaction for the item based on a configuration of the item transaction platform.

9. The computer implemented method of claim 7 further comprising:
determining, by the computer system, the set of transaction attributes for the item transaction for the item based on information about the seller and the potential buyer, wherein the information is selected from at least one of calendar information or payment options.

10. The computer implemented method of claim 1 further comprising:
sending, by the computer system, information about a missing item attribute to another potential buyer based on a set of rules in response to an interaction from the another potential buyer requesting the missing item attribute.

11. The computer implemented method of claim 1, wherein the item attributes and the set of missing item attributes have a type selected from at least one of text, an image, or a video.

12. A computer system comprising a number of processor units, wherein the number of processor units executes program instructions to:
train a machine learning model using training data comprising historical interactions and user profiles for a seller and a potential buyer;
determine, using the machine learning model, item attributes in an item profile for an item offered by the seller on an item transaction platform;
identify, using the machine learning model, interactions between the seller and the potential buyer regarding the item;
determine, using the machine learning model, a set of missing item attributes from the item profile based on the interactions between the seller and the potential buyer;
recommend, using the machine learning model, a set of actions that relate to the set of missing item attributes for the potential buyer to the seller of the item in a recommendation, wherein the set of actions reduce the need for the seller to respond to each request for the set of missing item attributes;
perform the set of actions in the recommendation using the set of missing item attributes in response to a user input from the seller responding to the recommendation; and
automatically perform the set of actions in the recommendation using the set of missing item attributes for other potential buyers to reduce network traffic and bandwidth use by the item transaction platform.

13. The computer system of claim 12, wherein the set of actions is selected from at least one of updating the item profile with the set of missing item attributes, sending a response to an interaction from another potential buyer requesting the set of missing item attributes, or sending the set of missing item attributes to a set of potential buyers in a same buyer cluster as the potential buyer.

14. The computer system of claim 12, wherein the interactions is selected from at least one of communications between the seller of the item and a set of potential buyers, interactions between sellers and potential buyers regarding the set of missing item attributes for items of a same type as the item offered on the item transaction platform, or communications on a discussion forum on an online platform discussing the set of missing item attributes for the item.

15. The computer system of claim 12, wherein the number of processor units executes program instructions to:
determine potential buyers for the item to form identified potential buyers;
determine the set of missing item attributes based on the identified potential buyers and interactions between the identified potential buyers; and
recommending the set of actions for the set of missing item attributes identified for the identified potential buyers in the recommendation.

16. The computer system of claim 12, wherein the number of processor units executes program instructions to:
determine a set of constraints on item attributes for the seller of the item; and
recommend the set of missing item attributes based on the interactions with the potential buyer and the set of constraints.

17. The computer system of claim 12, wherein the number of processor units executes program instructions to:
recommend a set of transaction attributes for an item transaction for the item.

18. The computer system of claim 17, wherein the number of processor units executes program instructions to:
determine the set of transaction attributes for the item transaction for the item based on a configuration of the item transaction platform.

19. The computer system of claim 17, wherein the number of processor units executes program instructions to:
determine the set of transaction attributes for the item transaction for the item based on information about the seller and the potential buyer, wherein the information is selected from at least one of calendar information or payment options.

20. A computer program product for recommending item attributes, the computer program product comprising a computer readable storage medium having program instructions embodied therewith, the program instructions executable by a computer system to cause the computer system to perform a method of:
training a machine learning model using training data comprising historical interactions and user profiles for a seller and a potential buyer;
determining, using the machine learning model, the item attributes in an item profile for an item offered by a seller on an item transaction platform;
identifying, using the machine learning model, interactions between the seller and a potential buyer regarding the item;
determining, using the machine learning model, a set of missing item attributes from the item profile based on the interactions between the seller and the potential buyer;
recommending, using the machine learning model, a set of actions that relate to the set of missing item attributes for the potential buyer to the seller of the item in a recommendation, wherein the set of actions reduce the need for the seller to respond to each request for the set of missing item attributes;
performing the set of actions in the recommendation using the set of missing item attributes in response to a user input from the seller responding to the recommendation; and
automatically performing, the set of actions in the recommendation using the set of missing item attributes for other potential buyers to reduce network traffic and bandwidth use by the item transaction platform.
